(19) United States
(12) Patent Application Publication
(10) Pub. No.: US 2026/0370265 A1
(43) Pub. Date: Nov. 19, 2026

(54) USER EQUIPMENT (UE)-CONTROLLED RECONFIGURABLE INTELLIGENT DEVICE (RID) DELAY CALIBRATION FOR POSITIONING

(71) Applicant: QUALCOMM Incorporated, San Diego, CA (US)

(72) Inventors: Sourjya DUTTA, Jersey City, NJ (US); Navid ABEDINI, Basking Ridge, NJ (US); Alexandros MANOLAKOS, Athens (GR); Kapil GULATI, Belle Mead, NJ (US)

(21) Appl. No.: 19/470,600

(22) PCT Filed: May 31, 2024
(86) PCT No.: PCT/US2024/031820

§ 371 Date: Sep. 29, 2025

(30) Foreign Application Priority Data
Jun. 6, 2023 (GR) 20230100449

(51) Int. Cl. H04B 7/04; H04B 17/11; H04W 24/10

(52) U.S. Cl. CPC H04B 7/04013; H04B 17/11; H04W 24/10

(57) ABSTRACT

Disclosed are techniques for wireless communication. In an aspect, a user equipment (UE) transmits, to a reconfigurable intelligence device (RID) controller, a calibration request for calibration information associated with a RID associated with the RID controller, receives, from the RID controller, in response to the calibration request, a calibration response, and transmits, to a network entity, based on the calibration response from the RID controller, a calibration report indicating the calibration information associated with the RID.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a user equipment (UE) includes transmitting, to a reconfigurable intelligence device (RID) controller, a calibration request for calibration information associated with a RID associated with the RID controller; receiving, from the RID controller, in response to the calibration request, a calibration response; and transmitting, to a network entity, based on the calibration response from the RID controller, a calibration report indicating the calibration information associated with the RID.

In an aspect, a method of communication performed by a network entity includes receiving, from a user equipment (UE), a calibration report indicating calibration information associated with a reconfigurable intelligence device (RID); and transmitting, to the UE, a first configuration to perform a calibration operation to determine a delay associated with the RID, wherein the first configuration indicates one or more downlink reference signals transmitted by one or more transmission-reception points (TRPs) to be measured by the UE.

In an aspect, a user equipment (UE) includes at least one memory; at least one transceiver; and at least one processor communicatively coupled to the at least one memory and the at least one transceiver, the at least one processor configured to: transmit, via the at least one transceiver, to a reconfigurable intelligence device (RID) controller, a calibration request for calibration information associated with a RID associated with the RID controller; receive, via the at least one transceiver, from the RID controller, in response to the calibration request, a calibration response; and transmit, via the at least one transceiver, to a network entity, based on the calibration response from the RID controller, a calibration report indicating the calibration information associated with the RID.

In an aspect, a network entity includes at least one memory; at least one transceiver; and at least one processor communicatively coupled to the at least one memory and the at least one transceiver, the at least one processor configured to: receive, via the at least one transceiver, from a user equipment (UE), a calibration report indicating calibration information associated with a reconfigurable intelligence device (RID); and transmit, via the at least one transceiver, to the UE, a first configuration to perform a calibration operation to determine a delay associated with the RID, wherein the first configuration indicates one or more downlink reference signals transmitted by one or more transmission-reception points (TRPs) to be measured by the UE.

In an aspect, a user equipment (UE) includes means for transmitting, to a reconfigurable intelligence device (RID) controller, a calibration request for calibration information associated with a RID associated with the RID controller; means for receiving, from the RID controller, in response to the calibration request, a calibration response; and means for transmitting, to a network entity, based on the calibration response from the RID controller, a calibration report indicating the calibration information associated with the RID.

In an aspect, a network entity includes means for receiving, from a user equipment (UE), a calibration report indicating calibration information associated with a reconfigurable intelligence device (RID); and means for transmitting, to the UE, a first configuration to perform a calibration operation to determine a delay associated with the RID, wherein the first configuration indicates one or more downlink reference signals transmitted by one or more transmission-reception points (TRPs) to be measured by the UE.

In an aspect, a non-transitory computer-readable medium stores computer-executable instructions that, when executed by a user equipment (UE), cause the UE to: transmit, to a reconfigurable intelligence device (RID) controller, a calibration request for calibration information associated with a RID associated with the RID controller; receive, from the RID controller, in response to the calibration request, a calibration response; and transmit, to a network entity, based on the calibration response from the RID controller, a calibration report indicating the calibration information associated with the RID.

In an aspect, a non-transitory computer-readable medium stores computer-executable instructions that, when executed by a network entity, cause the network entity to: receive, from a user equipment (UE), a calibration report indicating calibration information associated with a reconfigurable intelligence device (RID); and transmit, to the UE, a first configuration to perform a calibration operation to determine a delay associated with the RID, wherein the first configuration indicates one or more downlink reference signals transmitted by one or more transmission-reception points (TRPs) to be measured by the UE.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates examples of various positioning methods supported in New Radio (NR), according to aspects of the disclosure.

FIG. 5 is a diagram illustrating an example sidelink ranging and positioning procedure, according to aspects of the disclosure.

FIG. 6 illustrates an example system for wireless communication using a reconfigurable intelligent surface (RIS), according to aspects of the disclosure.

FIGS. 7A to 7D illustrate the differences between a repeater function and a relay function.

FIG. 8 is a diagram illustrating an example of a UE-controlled reconfigurable intelligent device (RID) deployment scenario, according to aspects of the disclosure.

FIGS. 9 and 10 illustrate example methods of communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to reconfigurable intelligent devices (RIDs). Some aspects more specifically relate to determining calibration information for a RID. In some examples, a target user equipment (UE) may transmit a calibration request to a RID controller for calibration information associated with a RID associated with the RID controller. The RID controller may respond to the calibration request with a calibration response that either includes a delay associated with the RID or an indication that the delay information is not available. The target UE can then transmit a calibration report to a network entity (e.g., a base station or location server) indicating the calibration information associated with the RID. In response, the network entity can configure a calibration operation if needed.

Particular aspects of the subject matter described in this disclosure can be implemented to realize one or more of the following potential advantages. In some examples, by obtaining calibration information for a RID, the described techniques can be used to improve the accuracy of timing measurements of reference signals retransmitted by the RID, thereby improving positioning accuracy.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

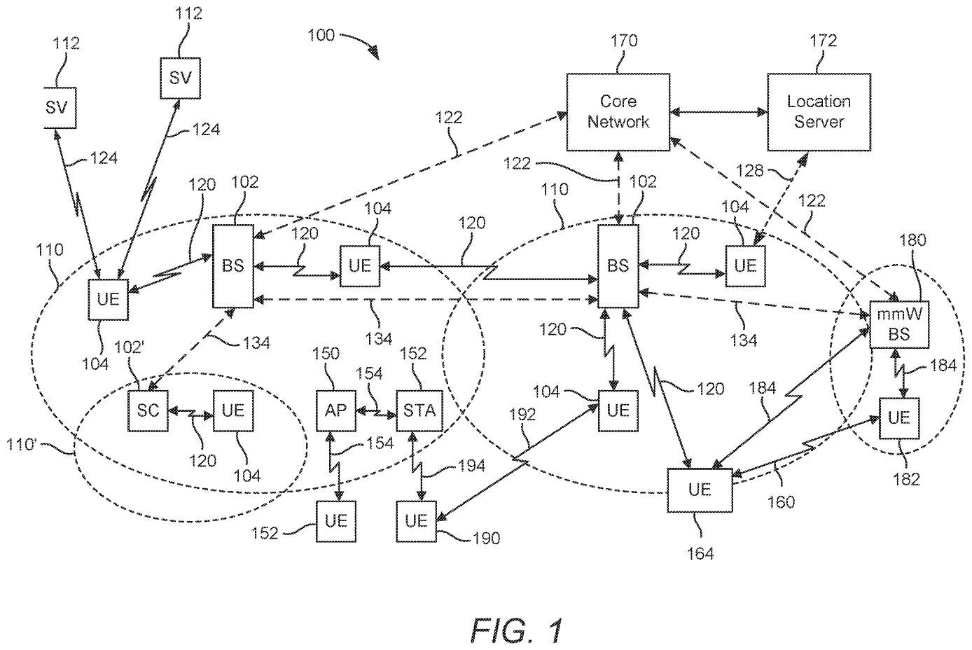

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHZ). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mm W or near mm W and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz), Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier.” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mm W base station 180 may support one or more SCells for the UE 164.

In some cases, the UE 164 and the UB 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

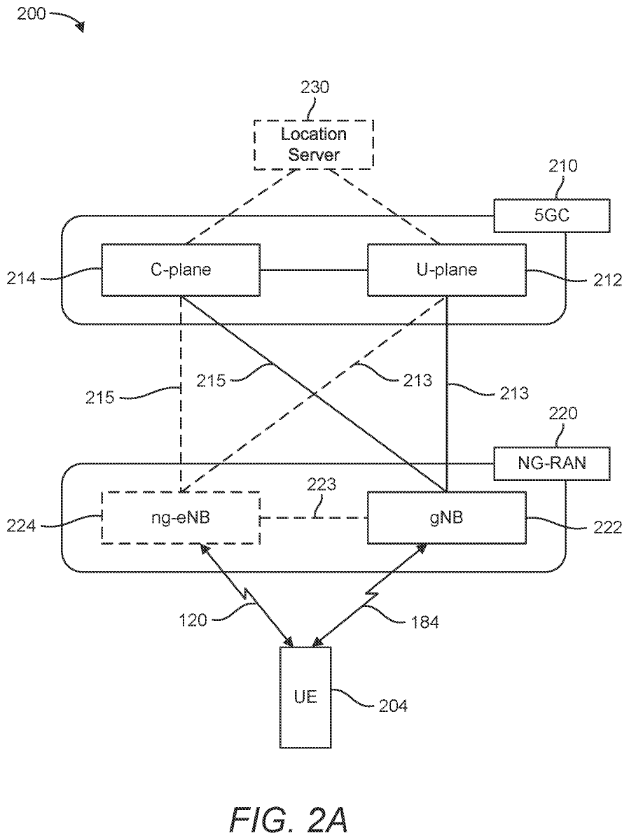

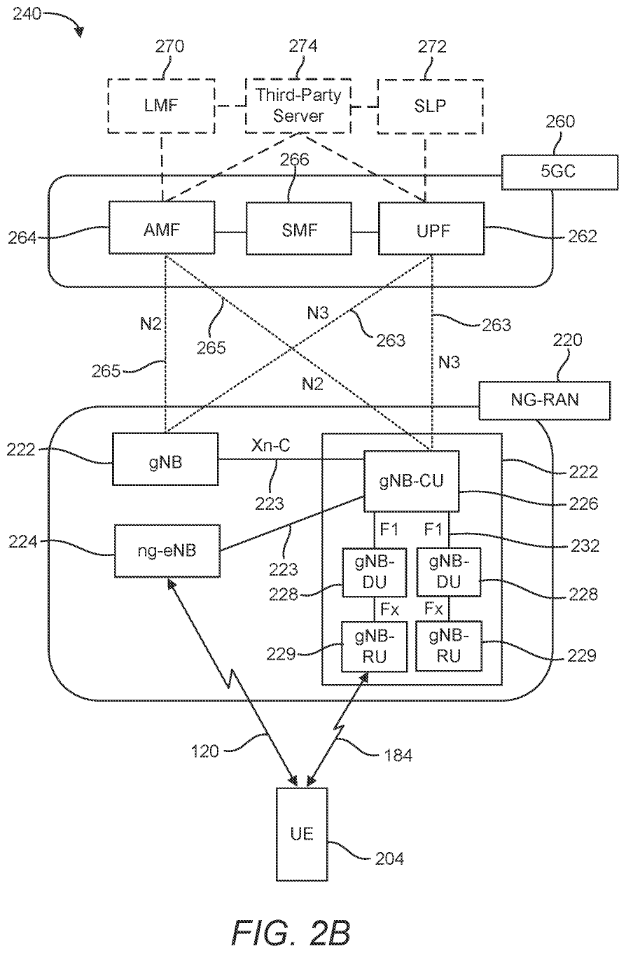

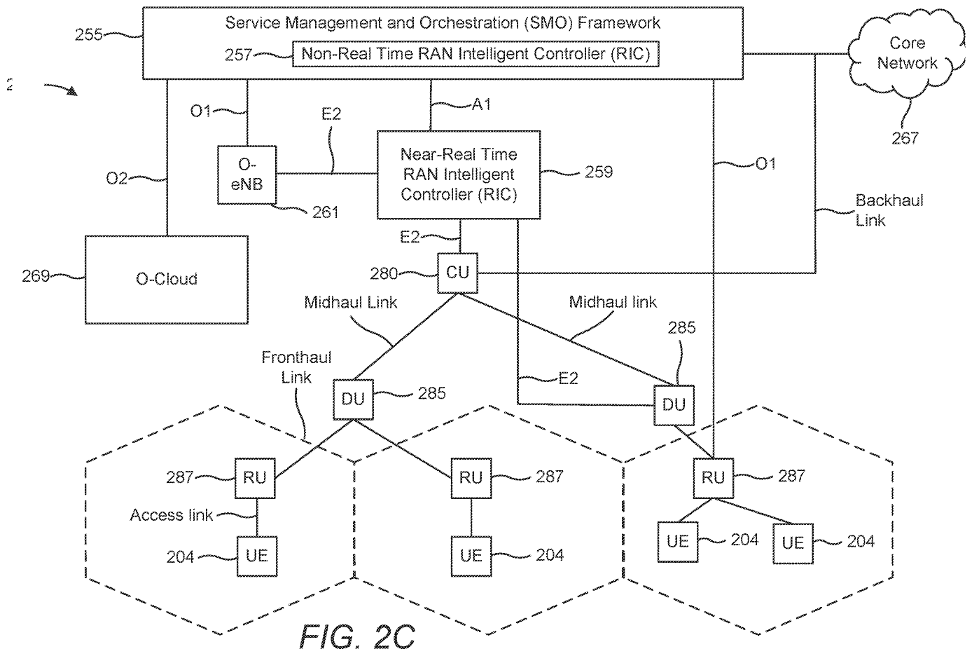

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, access point (AP), a transmit receive point (TRP), or a cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUs 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via 01) or via creation of RAN management policies (such as A1 policies).

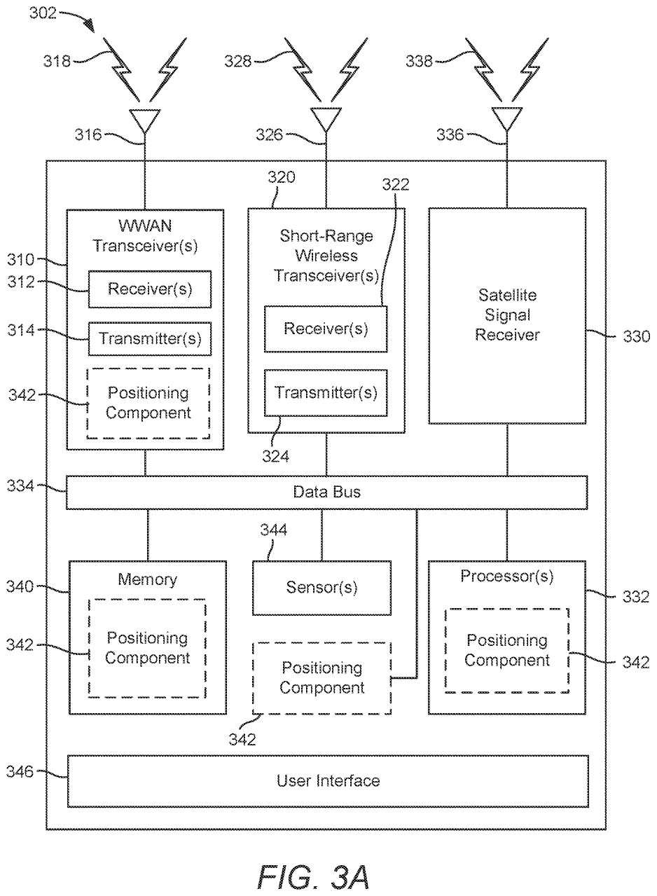

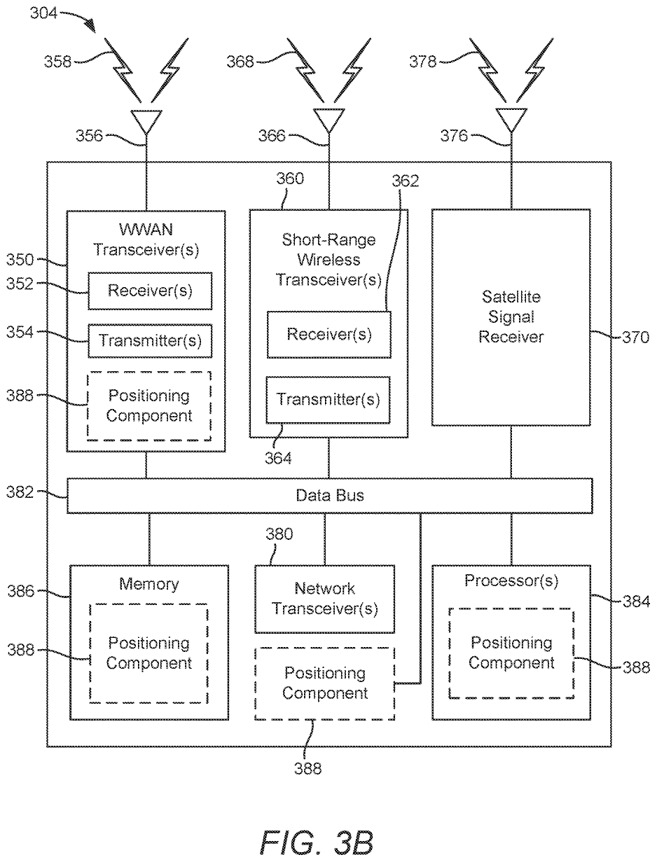

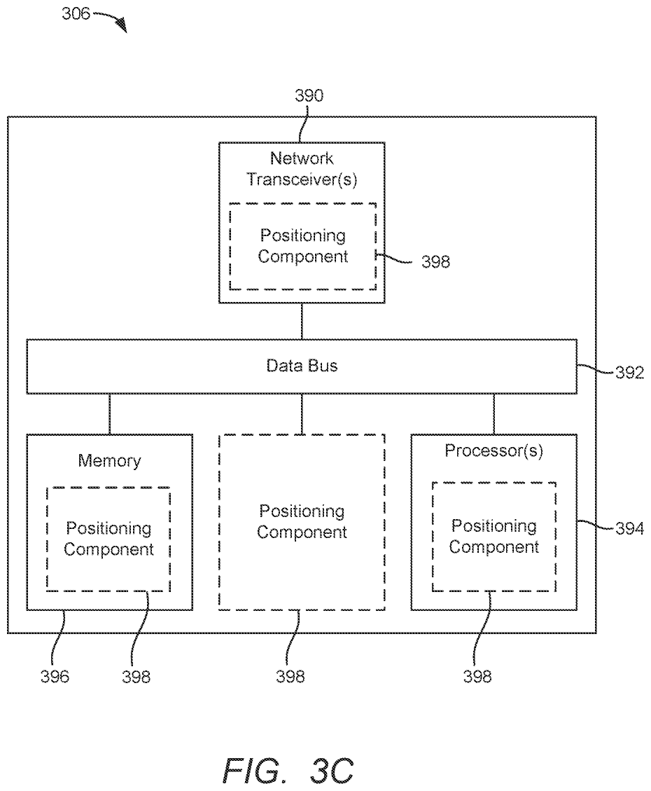

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum).

The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS®) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver.” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 342, 388, and 398, respectively. The positioning component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning component 342, 388, and 398 may be external to the processors 332, 384, and 394 (e.g., part of a modem processing system, integrated with another processing system, etc.). Alternatively, the positioning component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning component 342, which may be, for example, part of the one or more WWAN transceivers 310, the memory 340, the one or more processors 332, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the downlink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

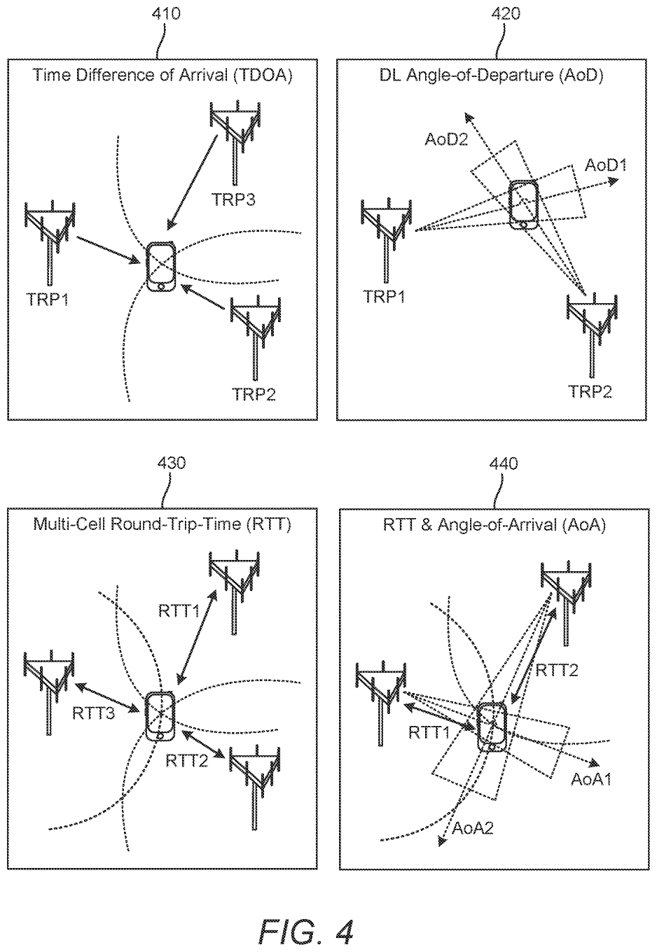

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 4 illustrates examples of various positioning methods, according to aspects of the disclosure. In an OTDOA or DL-TDOA positioning procedure, illustrated by scenario 410, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 420, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 430, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 440.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

NR is capable of supporting various sidelink ranging and positioning techniques. Sidelink-based ranging enables the determination of the relative distance(s) between UEs and optionally their absolute position(s), where the absolute position of at least one involved UE is known. This technique is valuable in situations where global navigation satellite system (GNSS) positioning is degraded or unavailable (e.g., tunnels, urban canyons, etc.) and can also enhance range and positioning accuracy when GNSS is available. Sidelink-based ranging can be accomplished using a three-way handshake for session establishment, followed by the exchange of positioning reference signals (PRS), and concluded by messaging to exchange measurements based on PRS transmission and receipt from peer UEs.

Sidelink ranging is based on calculating an inter-UE round-trip-time (RTT) measurement, as determined from the transmit and receive times of PRS (a wideband positioning signal defined in LTE and NR). Each UE reports an RTT measurement to all other participating UEs, along with its location (if known). For UEs having zero or inaccurate knowledge of their location, the RTT procedure yields an inter-UE range between the involved UEs. For UEs having accurate knowledge of their location, the range yields an absolute position. UE participation, PRS transmission, and subsequent RTT calculation is coordinated by an initial three-way messaging handshake (a PRS request, a PRS response, and a PRS confirmation), and a message exchange after PRS transmission (post PRS messages) to share measurements after receiving a peer UE's PRS.

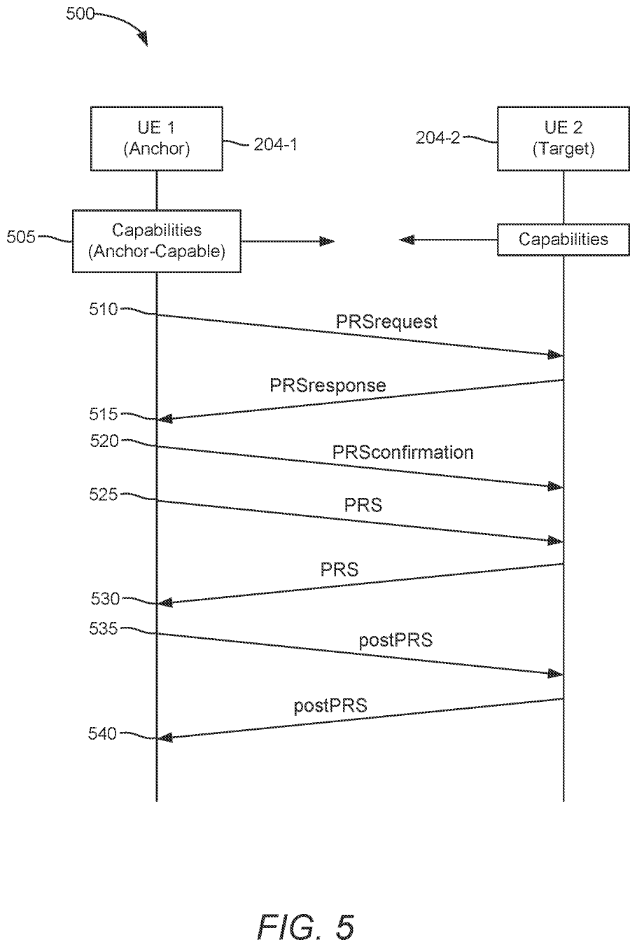

FIG. 5 illustrates an example sidelink ranging and positioning procedure 500, according to aspects of the disclosure. The sidelink ranging and positioning procedure 500 may also be referred to as a sidelink RTT positioning procedure. Sidelink ranging is based on calculating an inter-UE RTT measurement, as determined from the transmit and receive times of PRS (a wideband reference signal defined in LTE and NR for positioning). Each UE reports an RTT measurement to all other participating UEs, along with its location (if known). For UEs having zero or inaccurate knowledge of their location, the RTT procedure yields an inter-UE range between the involved UEs. For UEs having accurate knowledge of their location, the range yields an absolute location. UE participation, PRS transmission, and subsequent RTT calculation is coordinated by an initial three-way messaging handshake (a PRS request, a PRS response, and a PRS confirmation), and a message exchange after PRS transmission (post PRS messages) to share measurements after receiving a peer UE's PRS.

The sidelink ranging and positioning procedure 500 (or session) begins with the broadcast of capability information by the involved peer UEs at stage 505. As shown in FIG. 5, one of the peer UEs, UE 204-1 (e.g., any of the sidelink-capable UEs described herein), is capable of being an anchor UE for the sidelink ranging and positioning procedure 500, meaning it has a known location. As such, the anchor UE 204-1 includes an indication in its capability message(s) that it is capable of being an anchor UE for the sidelink ranging and positioning procedure 500. The capability message(s) may also include the location of the anchor UE 204-1, or this may be provided later. The other UE, UE 204-2 (e.g., any other of the sidelink-capable UEs described herein), is a target UE, meaning it has an unknown or inaccurate location and is attempting to be located. Based on the capability information received from the anchor UE 204-1, indicating that the anchor UE 204-1 is an anchor UE, the target UE 204-2 knows that it will be able to determine its location based on performing the sidelink ranging and positioning procedure 500 with the anchor UE 204-1.

After the initial capability exchange, the involved UEs 204 perform a three-way messaging handshake. At stage 510, the anchor UE 204-1 transmits a PRS request (labeled “PRSrequest”) to the target UE 204-2. At stage 515, the target UE 204-2 transmits a PRS response (labeled “PRSresponse”) to the anchor UE 204-1. At stage 520, the anchor UE 204-1 transmits a PRS confirmation to the target UE 204-2. At this point, the three-way messaging handshake is complete. Note that although FIG. 5 illustrates the anchor UE 204-1 initiating the three-way message handshake, it may instead be initiated by the target UE 204-2.

At stages 525 and 530, the involved peer UEs 204 transmit PRS to each other. The resources on which the PRS are transmitted may be configured/allocated by the network (e.g., one of the UE's 204 serving base station) or negotiated by the UEs 204 during the three-way messaging handshake. The anchor UE 204-1 measures the transmission-to-reception (Tx-Rx) time difference between the transmission time of PRS at stage 525 and the reception time of PRS at stage 530. The target UE 204-2 measures the reception-to-transmission (Rx-Tx) time difference between the reception time of PRS at stage 525 and the transmission time of PRS at stage 530. Note that although FIG. 5 illustrates the anchor UE 204-1 transmitting PRS first, the target UE 204-2 may instead transmit PRS first.

At stages 535 and 540, the peer UEs 204 exchange their respective time difference measurements in post PRS messages (labeled “postPRS”). If the anchor UE 204-1 has not yet provided its location to the target UE 204-2, it does so at this point. Each UE 204 is then able to determine the RTT between each UE 204 based on the Tx-Rx and Rx-Tx time difference measurements (specifically, the difference between the Tx-Rx and Rx-Tx time difference measurements). Based on the RTT measurement and the speed of light, each UE 204 can then estimate the distance (or range) between the two UEs 204 (specifically, half the RTT measurement multiplied by the speed of light). Since the target UE 204-2 also has the absolute location (e.g., geographic coordinates) of the anchor UE 204-1, the target UE 204-2 can use that location and the distance to the anchor UE 204-1 to determine its own absolute location.

Note that while FIG. 5 illustrates two UEs 204, a UE may perform, or attempt to perform, the sidelink ranging and positioning procedure 500 with multiple UEs.

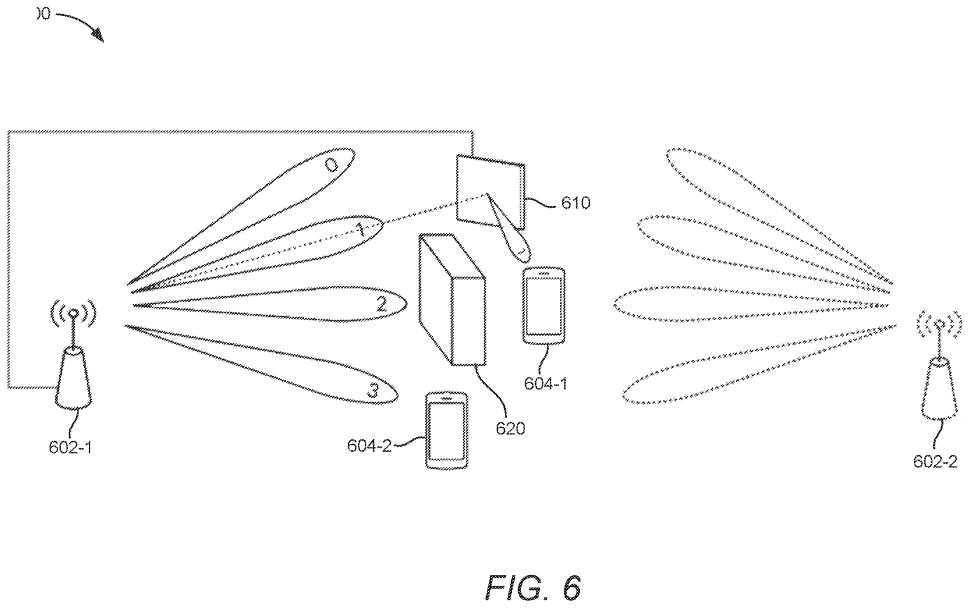

FIG. 6 illustrates an example system 600 for wireless communication using a reconfigurable intelligent surface (RIS) 610, according to aspects of the disclosure. An RIS (e.g., RIS 610) is a two-dimensional surface comprising a large number of low-cost, low-power, near-passive reflecting elements whose properties are reconfigurable (e.g., by software or control signals) rather than static. For example, by carefully tuning the phase shifts of the reflecting elements (e.g., using software or control signals), the scattering, absorption, reflection, and diffraction properties of an RIS can be changed over time. In that way, the electromagnetic (EM) properties of an RIS can be engineered to collect wireless signals from a transmitter (e.g., a base station, a UE, etc.) and passively beamform them towards a target receiver (e.g., another base station, another UE, etc.). In the example of FIG. 6, a first base station 602-1 controls the reflective properties of an RIS 610 in order to communicate with a first UE 604-1.

The goal of RIS technology is to create smart radio environments, where the wireless propagation conditions are co-engineered with the physical layer signaling. This enhanced functionality of the system 600 can provide technical benefits in a number of scenarios.

As a first example scenario, as shown in FIG. 6, the first base station 602-1 (e.g., any of the base station described herein) is attempting to transmit downlink wireless signals to the first UE 604-1 and a second UE 604-2 (e.g., any two of the UEs described herein, collectively, UEs 604) on a plurality of downlink transmit beams, labeled “0,” “1,” “2,” and “3.” However, unlike the second UE 604-2, because the first UE 604-1 is behind an obstacle 620 (e.g., a building, a hill, or another type of obstacle), it cannot receive the wireless signal on what would otherwise be the line-of-sight (LOS) beam from the first base station 602-1, that is, the downlink transmit beam labeled “2.” In this scenario, the first base station 602-1 may instead use the downlink transmit beam labeled “1” to transmit the wireless signal to the RIS 610, and configure the RIS 610 to reflect/beamform the incoming wireless signal towards the first UE 604-1. The first base station 602-1 can thereby transmit the wireless signal around the obstacle 620.

Note that the first base station 602-1 may also configure the RIS 610 for the first UE's 604-1 use in the uplink. In that case, the first base station 602-1 may configure the RIS 610 to reflect an uplink signal from the first UE 604-1 to the first base station 602-1, thereby enabling the first UE 604-1 to transmit the uplink signal around the obstacle 620.

As another example scenario in which system 600 can provide a technical advantage, the first base station 602-1 may be aware that the obstacle 620 may create a “dead zone,” that is, a geographic area in which the downlink wireless signals from the first base station 602-1 are too attenuated to be reliably detected by a UE within that area (e.g., the first UE 604-1). In this scenario, the first base station 602-1 may configure the RIS 610 to reflect downlink wireless signals into the dead zone in order to provide coverage to UEs that may be located there, including UEs about which the first base station 602-1 is not aware.

An RIS (e.g., RIS 610) may be designed to operate in either a first mode (referred to as “Mode 1”), in which the RIS operates as a reconfigurable mirror, or a second mode (referred to as “Mode 2”), in which the RIS operates as a receiver and transmitter (similar to the amplify and forward functionality of a relay node). Some RIS may be designed to be able to operate in either Mode 1 or Mode 2, while other RIS may be designed to operate only in either Mode 1 or Mode 2. Mode 1 RIS are assumed to have a negligible hardware group delay, whereas Mode 2 RIS have a non-negligible hardware group delay due to being equipped with limited baseband processing capability. Because of their greater processing capability compared to Mode 1 RIS, Mode 2 RIS may, in some cases, be able to compute and report their transmission-to-reception (Tx-Rx) time difference measurements (i.e., the difference between the time a signal is reflected towards a UE and the time the signal is received back from the UE). In the example of FIG. 6, the RIS 610 may be either a Mode 1 or Mode 2 RIS.

FIG. 6 also illustrates a second base station 602-2 that may transmit downlink wireless signals to one or both of the UEs 604. As an example, the first base station 602-1 may be a serving base station for the UEs 604 and the second base station 602-2 may be a neighboring base station. The second base station 602-2 may transmit downlink positioning reference signals to one or both of the UEs 604 as part of a positioning procedure involving the UE(s) 604. Alternatively or additionally, the second base station 602-2 may be a secondary cell for one or both of the UEs 604. In some cases, the second base station 602-2 may also be able to reconfigure the RIS 610, provided it is not being controlled by the first base station 602-1 at the time.

Note that while FIG. 6 illustrates one RIS 610 and one base station controlling the RIS 610 (i.e., the first base station 602-1), the first base station 602-1 may control multiple RIS 610. In addition, the RIS 610 may be controlled by multiple base stations 602 (e.g., both the first and second base stations 602-1 and 602-2, and possibly more).

A cellular repeater may also be used to improve network connectivity. A repeater commonly includes a donor antenna that receives downlink signals from nearby base stations and a rebroadcast antenna that transmits the downlink signals to one or more UEs. On the uplink, the rebroadcast antenna receives uplink signals from the one or more UEs and the donor antenna transmits the signals to the nearby base stations. Repeater communication can increase throughput, data rate, and cellular coverage, and is especially beneficial due to its ability to increase the diversity gain in a fading environment.

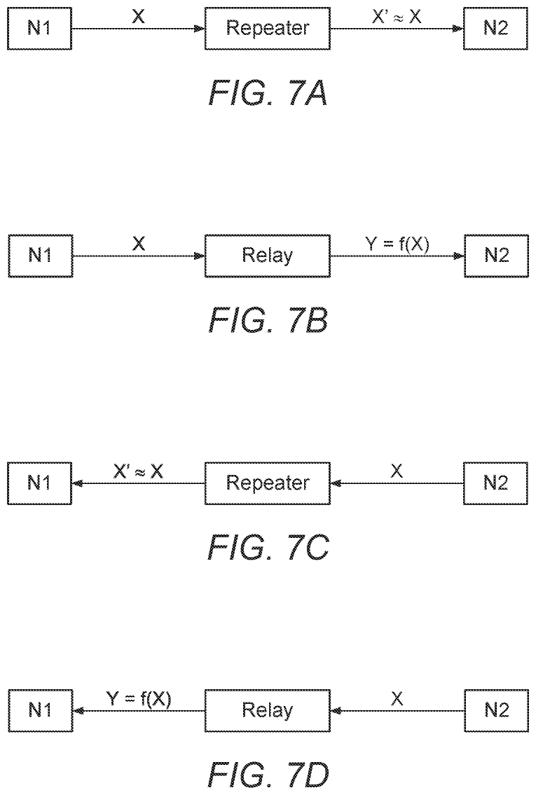

FIGS. 7A to 7D illustrate the differences between a repeater function and a relay function, as well as some technical challenges faced by conventional repeater and relay functions. As used herein, the generic term repeater/relay unit (RU) is used to refer to a network node that performs a repeater function, a relay function, or both. Where the RU does a particular function, repeater or relay, that will be so indicated.

FIG. 7A shows a repeater function, in which a repeater receives a first signal (labeled “X”) from a transmitter node (labeled “N1”) and sends a second signal (labeled “X”) to a receiver node (labeled “N2”). In this scenario, the repeater essentially regenerates the signal X as X′, for example, by duplicating the tones of X. From a signal processing point of view, X and X′ would appear the same at the receiver node N2.

In one example, the transmitter node N1 may be a gNB and the receiver node N2 may be a UE, in which case, the connection between the gNB and the repeater is referred to as a fronthaul link, while the connection between the repeater and the UE is referred to as an access link. Thus, the examples illustrated in FIGS. 7A to 7D are referred to as integrated access fronthaul (IAF) networks.

FIG. 7B shows a relay function, in which a relay node receives a first signal (labeled “X”) from a transmitter node (labeled “N1”) and generates a second signal (labeled “Y”), which carries information about or from the first signal X. The relay node does not replicate the tones of the original signal X, but instead, contains essentially the same content as the first signal X, but in a different form (represented as “f(X)”). As a downlink example, signal X may be a front-haul physical downlink shared channel (FH-PDSCH) having a payload that carries some information (e.g., IQ samples), and signal Y may be a legacy PDSCH that is generated based upon that information. As an uplink example, signal X may be a legacy PUSCH and signal Y may be a FH-PUSCH having a payload that carries some information acquired from signal X.

FIG. 7C shows the repeater of FIG. 7A, but with the roles of the transmitter node X1 and receiver node X2 reversed. Similarly, FIG. 7D shows the relay of FIG. 7C, but with the roles of the transmitter node X1 and receiver node X2 reversed.

Any controllable device in the wireless communication medium between a transmitter and a receiver that can improve link quality is referred to as a reconfigurable intelligent device (RID). A passive RID is one that does not need any power or control, such as a passive meta-surface installed on a window to reduce/eliminate outdoor-to-indoor (O2I) penetration loss. An active RID can refer to repeaters (as described above with reference to FIGS. 7A-7D), RIS (as described above with reference to FIG. 6), and the like. Active RIDs may boost signal strength and/or steer the signals in a required direction based on some control.

Active RIDs are controlled by a RID controller that has communication capabilities. The RID controller may be a base station (e.g., a gNB), RSU, UE, or the like. The RID controller may communicate with other communication nodes to determine the RID configuration.

As noted, RIDs may be controlled by a network entity (referred to as “network-controlled”) or a UE (referred to as “UE-controlled”). For RIDs with network control, there may be multiple RIDs deployed by a network operator and controlled by a network entity (e.g., agNB). Where the network entity is a base station, the base station can notify the UEs connected to it about the presence of the RID. The base station can schedule access to the RID and control the properties/characteristics of the RID to benefit transmission between the devices (e.g., between the base station and a UE or between UEs). The base station can perform this coordination because it knows where the RID is located and has at least some information about the position(s) and channel condition(s) of the UEs connected to it.

Referring now to UE-controlled RIDs, in this case, the deployment of control devices (the UEs) is distributed among one or more UEs, and the RID may or may not also be controlled by a central/network entity. For example, one or more RIDs may be mounted on a large vehicle (e.g., bus, truck, etc.) with sidelink capability. These may be useful to sidelink users outside network coverage, for example. In the case the UE is the RID controller, the UE needs to discover the RID(s) in order to use them. The present disclosure assumes that each RID is controlled by a RID controller that at least has the capability to communicate over a sidelink connection.

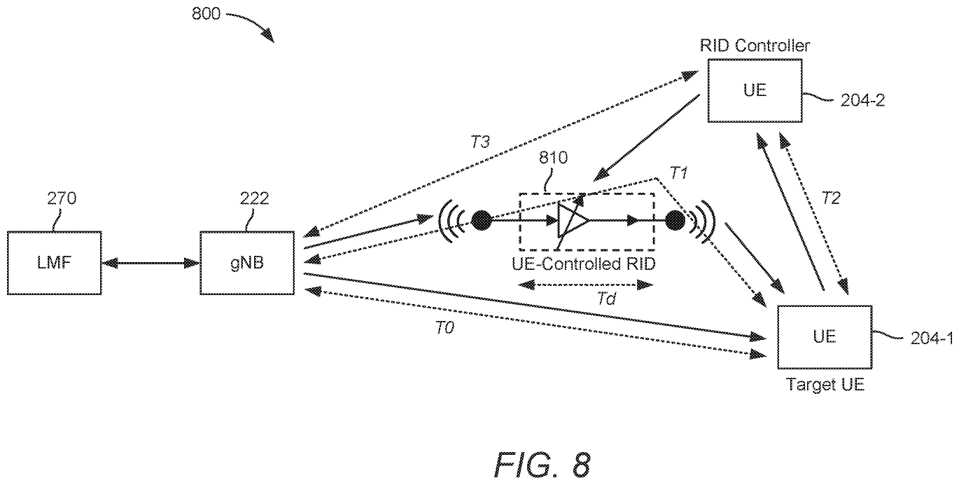

FIG. 8 is a diagram 800 illustrating an example of a UE-controlled RID deployment scenario, according to aspects of the disclosure. As shown in FIG. 8, a target UE 204-1 communicates with a second UE 204-2 (e.g., handheld UE, vehicular UE, RSU, etc.) over a side channel (e.g., sidelink) to access and configure a RID 810 to improve one or more links. These links may be Uu links (between the target UE 204-1 and the gNB 222) or other D2D links (e.g., other sidelinks).

A RID (e.g., RID 810) may introduce a delay in the downlink or sidelink signal received at a UE (e.g., target UE 204-1 and/or UE 204-2) or an uplink signal received at a base station (e.g., gNB 222). For example, where the RID 810 is a repeater, there will be a delay associated with the repeater amplifying and forwarding the signal received from one entity (e.g., gNB 222) to another entity (e.g., target UE 204-1). The delay may be associated with the signal propagation in the internal circuitry of the RID 810 as well as entity switching.

For a network-controlled RID, this delay may be calibrated and known to the network (based on deployment). For a UE-controlled RID, however, as in the example of FIG. 8, the RID delay calibration may not (in general) be available at the network. As such, positioning algorithms at the LMF 270 will need information on this additional signal delay to correctly estimate the position of the target UE 204-1. For instance, this additional delay will affect RTT-based and TDOA-based measurements.

Accordingly, the present disclosure provides techniques for the estimation and exchange of RID delay(s) between the RID controller (e.g., UE 204-2), the target UE (e.g., target UE 204-1), and the network (e.g., gNB 222).

Note that the term “delay,” as used herein, refers to the propagation time (e.g., time of flight (ToF)) of a wireless signal. For example, the delay associated with a RID is the difference between the time the RID receives a wireless signal and the time it retransmits the wireless signal. The delay between the gNB 222 and the target UE 204-1 is the ToF of a wireless signal transmitted between the gNB 222 and the target UE 204-1. The ToF may be calculated using, for example, RTT-based techniques, as is known in the art. Similarly, the delay between the target UE 204-1 and the RID controller UE 204-2 is the ToF of a wireless signal transmitted between the target UE 204-1 and the RID controller UE 204-2. The ToF may be calculated using, for example, sidelink ranging-based techniques, as described above with reference to FIG. 5.

With continued reference to FIG. 8, in the network shown, the target UE 204-1 may be reached by the network (e.g., gNB 222) either through a direct path or via the RID 810. The RID 810 may be calibrated and T_{d} (denoted “Td” in the figure) may be known. However, when Ta is unknown or inaccurate, the delay introduced by the RID 810 (T_{d}) may still be determined/estimated. For example, in the example of FIG. 8, the delay between the gNB 222 and the target UE 204-1 based on the link through the RID (T₁, denoted “T1” in the figure) may be determined. Next, the delay between the RID controller UE 204-2 and the gNB 222 (T₃, denoted “T3” in the figure) may be determined. Next, the delay between the RID controller UE 204-2 and the target UE 204-1 (T₂ denoted “T2” in the figure) may be determined. Then, Ta may be determined as T_{d}≈T₁−(T₂+T₃). Note that when the direct path is not very weak, the combined measurement may degrade the estimate of T₁.

As a first technique, the target UE 204-1 may provide the calibration notification for a RID (e.g., RID 810). In this case, the RID controller UE 204-2 can share its own local calibration results with the target UE 204-1. In an aspect, the calibration result may include an indication of a delay associated with the RID-based operation. In some cases, multiple values of the delay may be provided, where the multiple values may indicate the maximum delay, minimum delay, expected/mean delay, and/or constant delay. In an aspect, the RID controller UE 204-2 may provide an additional indication of a calibration error or measure(s) of variance for the RID. In an aspect, the RID controller UE 204-2 may provide an additional indication of the precision of the measurement

If the UE 204-1 is actively seeking assistance from a UE-controlled RID (e.g., RID 810), then in an aspect, the target UE 204-1 may send a RID delay calibration notification to the network (e.g., LMF 270). In an aspect, the target UE 204-1 may forward the calibration information received from the RID controller UE 204-2 to the network in the calibration notification (or report). Alternatively, the target UE 204-1 may send a notification to the network that no calibration information was received from the RID controller UE 204-2. In an aspect, the calibration notification may include a unique identifier for the RID controller UE 204-2.

In some cases, the target UE 204-1 may determine that more accurate measurement is required and send an indication to the network for the need to perform a calibration procedure. In an aspect, after sending the calibration notification (or report), the target UE 204-1 should wait for the network to indicate whether additional calibration steps are required.

As a second technique, the over-the-air (OTA) delay between the network (e.g., gNB 222), the target UE 204-1, and the RID controller UE 204-2 may be estimated. In this case, the network entity (e.g., LMF 270) may determine to perform OTA RID delay calibration. This determination may be based on either the calibration report received from the target UE 204-1, or the indication (request) from the target UE 204-1 to perform addition delay calibration, or a combination of both.

The network may notify the target UE 204-1 about the additional calibration step. This notification may further include a set of reference signals (e.g., a set of PRS transmitted by gNB 222) that the target UE 204-1 should monitor for the additional calibration.

Regarding the network's connection to the RID controller UE 204-2, the network may determine that the RID controller UE 204-2 is already connected to the network (e.g., in an RRC Connected state). Alternatively, the network may page the RID controller UE 204-2 (which may be in an RRC Idle or Inactive state), establish a connection with the RID controller UE 204-2 for the OTA calibration, and provide information about the reference signal and resources to be measured for the delay measurement. As yet another alternative, the network may notify the target UE 204-1 to send a network connection establishment command to the RID controller UE 204-2 over the sidelink connection.

To determine the delay between the network (e.g., gNB 222) and the RID controller UE 204-2 (T₃) and the delay between the network and the target UE 204-1 (T₁), the network transmits a set of one or more reference signals to the RID controller UE 204-2 and the target UE 204-1. The RID controller UE 204-2 and the target UE 204-1 send (report) the measured timing information (e.g., ToA, ToF, propagation time, or the like) to the network. For example, the UEs may report the measurements to the gNB 222 via RRC signaling and/or to the LMF 270 via LPP. The network determines the RID delays based on these measurements and, in some cases, sends the estimation to the target UE 204-1 and/or the RID controller UE 204-2.

Regarding the OTA delay measurement between the target UE 204-1 and the RID controller UE 204-2 (T₂), in an aspect, the target UE 204-1 may be configured by the network (e.g., LMF 270) to determine the delay to the RID controller UE 204-2. In this case, the target UE 204-1 may use the sidelink channel to determine the delay (i.e., propagation time or ToF). To do so, the target UE 204-1 may request the timing advance associated with a known/common sidelink synchronization source. As another option, the target UE 204-1 may transmit a reference signal to the RID controller UE 204-2 and request the RID controller UE 204-2 to report back a time difference measurement. As another option, the target UE 204-1 may request the RID controller UE 204-2 to transmit a reference signal to enable the target UE 204-1 to perform the time difference measurement. As yet another option, the target UE 204-1 and the RID controller UE 204-2 may perform the reference signal transmission and the timing difference measurement based on a received network configuration.

Once the timing delay between the target UE 204-1 and the RID controller UE 204-2 has been determined, whichever of the target UE 204-1 and the RID controller UE 204-2 is performing the delay estimate sends the delay estimate either to the network, the other UE, or both.

Referring to the determination of the RID delay in greater detail, the target UE 204-1 or the network (e.g., gNB 222, LMF 270) may collect the delay information between the gNB 222, the RID controller UE 204-2, and the target UE 204-1 (T₁, T₂, T₃). Based on the collected delay estimations, the RID induced delay (T_{d}) can be determined. In an aspect, the target UE 204-1 may collect the delay information and notify the value of Ta to the network (e.g., gNB 222, LMF 270) and/or the RID controller UE 204-2.

Alternatively, the network may collect the delay information and notify the value of Ta to the target UE 204-1 and/or the RID controller UE 204-2.

In an aspect, the RID controller UE 204-2 may collect the delay information from the network and/or the target UE 204-1. Based on the delay information, the RID controller UE 204-2 may update its calibration results and send a calibration report to the target UE 204-1 and/or the network.

In an aspect, the target UE 204-1 may be a sidelink positioning reference UE (also referred to as an “anchor” UE). In this case, the target UE 204-1 may have accurate information about its position/location. In this case, the target UE 204-1 may request the RID controller UE 204-2 to provide its timing offset with respect to the target UE 204-1 or with respect to a specified common synchronization UE. The target UE 204-1 may further request the RID controller UE 204-2 to provide parameters associated with the RID being used (e.g., RID 810), such as the RID height compared to transceiver height, the RID location/orientation in space with respect to the RID controller UE 204-2 transceiver antennas, etc. The target UE 204-1 may further request the network (e.g., gNB 222, LMF 270) to indicate the location(s) of one (or more) TRPs (e.g., gNB 222) from which a DL-PRS is transmitted for the calibration purpose.

The target UE 204-1, on measuring the delay of the DL-PRS through the RID 810 and based on the location information of the RID controller UE 204-2 and the TRP (e.g., gNB 222) may determine the delay associated with the RID 810. In an aspect, the target UE 204-1 may forward the computed delay value to the RID controller UE 204-2 and/or the network.

In some cases, the estimation of T₁ may be incorrect due to the presence of a direct path T₀ (denoted “T0” in FIG. 8) between the gNB 222 and the target UE 204-1. As such, the target UE 204-1 needs to be able to distinguish the direct path (T₀) from a path (T₁) through the RID 810. Accordingly, in an aspect, the target UE 204-1 and the network (e.g., gNB 222) may perform a set of measurements with the RID 810 turned off. In this case, the target UE 204-1 may request the RID controller UE 204-2 to turn off the RID 810 during specified measurement occasions. A finer estimate of

$${T}_{1}^{e}$$

may be computed by the target UE 204-1 as

$${T}_{1}^{e} = ( 2 {T}_{1} - {α}_{0} {T}_{0} ) / {α}_{1} ,$$

where α₁, α₀ are based on the RSRP measured with the RID 810 turned ON and the RID 810 turned OFF, respectively.

In an aspect, the network may configure the target UE 204-1 to perform a coherent detection of the additional delay. In this case, the target UE 204-1 may be configured to receive reference signals (e.g., DL-PRS) over a specified slot. The target UE 204-1 will, in this case, request the RID controller UE 204-2 to turn the RID 810 ON over a set of symbols in this slot and then turn the RID 810 OFF over another set of symbols in this slot. The target UE 204-1 then subtracts the signal received over the second half of the slot with the signal received over the first half of the slot and performs the delay estimation with the resultant signal to obtain an estimate of T₁. The coherent detection may be enabled based on (a) the distance between target UE 204-1 and the RID controller UE 204-2, or (b) a comparison between the quality of the direct path (T₀) and the indirect path (T₁), or (c) the link quality between the target UE 204-1 and the RID controller UE 204-2. In any of these cases, the coherent detection may be enabled based on when the RID controller UE 204-2 can switch the RID 810 between the ON and OFF states within the configured switch symbols.

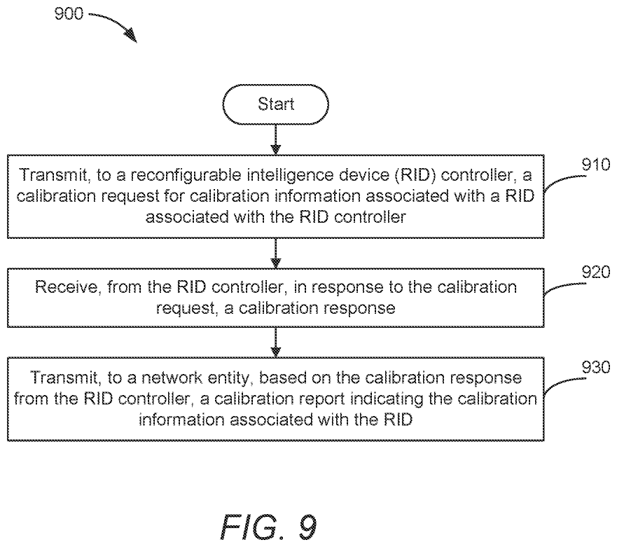

FIG. 9 illustrates an example method 900 of wireless communication, according to aspects of the disclosure. In an aspect, method 900 may be performed by a UE (e.g., target UE 204-1).

At 910, the UE transmits, to a RID controller (e.g., RID controller UE 204-2), a calibration request for calibration information associated with a RID (e.g., RID 810) associated with the RID controller. In an aspect, operation 910 may be performed by the one or more WWAN transceivers 310, the one or more processors 332, memory 340, and/or positioning component 342, any or all of which may be considered means for performing this operation.

At 920, the UE receives, from the RID controller, in response to the calibration request, a calibration response. In an aspect, operation 920 may be performed by the one or more WWAN transceivers 310, the one or more processors 332, memory 340, and/or positioning component 342, any or all of which may be considered means for performing this operation.

At 930, the UE transmits, to a network entity (e.g., gNB 222, LMF 270), based on the calibration response from the RID controller, a calibration report indicating the calibration information associated with the RID. In an aspect, operation 930 may be performed by the one or more WWAN transceivers 310, the one or more processors 332, memory 340, and/or positioning component 342, any or all of which may be considered means for performing this operation.

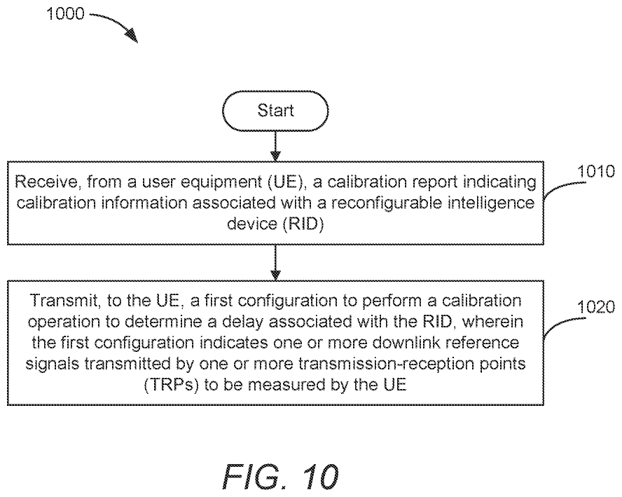

FIG. 10 illustrates an example method 1000 of communication, according to aspects of the disclosure. In an aspect, method 1000 may be performed by a network entity (e.g., gNB 222, LMF 270).

At 1010, the network entity receives, from a UE (e.g., target UE 204-1), a calibration report indicating calibration information associated with a RID (e.g., RID 810). In an aspect, operation 1010 may be performed by the one or more WWAN transceivers 350, the one or more processors 384, memory 386, and/or positioning component 388, any or all of which may be considered means for performing this operation. In an aspect, operation 1010 may be performed by the one or more network transceivers 390, the one or more processors 394, memory 396, and/or positioning component 398, any or all of which may be considered means for performing this operation.

At 1020, the network entity transmits, to the UE, a first configuration to perform a calibration operation to determine a delay associated with the RID, wherein the first configuration indicates one or more downlink reference signals transmitted by one or more TRPs (e.g., one or more gNBs 222) to be measured by the UE. In an aspect, operation 1020 may be performed by the one or more WWAN transceivers 350, the one or more processors 384, memory 386, and/or positioning component 388, any or all of which may be considered means for performing this operation. In an aspect, operation 1020 may be performed by the one or more network transceivers 390, the one or more processors 394, memory 396, and/or positioning component 398, any or all of which may be considered means for performing this operation.

As will be appreciated, a technical advantage of the methods 900 and 1000 is to correct for the error introduced by the forwarding delay of the RID in the positioning algorithm, thereby improving positioning performance.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a user equipment (UE), comprising: transmitting, to a reconfigurable intelligence device (RID) controller, a calibration request for calibration information associated with a RID associated with the RID controller; receiving, from the RID controller, in response to the calibration request, a calibration response; and transmitting, to a network entity, based on the calibration response from the RID controller, a calibration report indicating the calibration information associated with the RID.

Clause 2. The method of clause 1, wherein the calibration response from the RID controller includes: a constant value of a delay associated with the RID, a maximum value of the delay associated with the RID, a minimum value of the delay associated with the RID, an expected value of the delay associated with the RID, an average value of the delay associated with the RID, a mean value of the delay associated with the RID, a variance of the delay associated with the RID, a precision of the delay associated with the RID, an error associated with the delay associated with the RID, or any combination thereof.

Clause 3. The method of clause 1, wherein the calibration response received from the RID controller indicates that a delay associated with the RID is not available.

Clause 4. The method of any of clauses 1 to 3, wherein the calibration report includes: a value of a delay associated with the RID received in the calibration response, or an indication that the delay associated with the RID is not available.

Clause 5. The method of any of clauses 1 to 4, wherein the calibration report includes a unique identifier of the RID controller.

Clause 6. The method of any of clauses 1 to 5, further comprising: receiving, from the network entity, a configuration to perform a calibration operation to determine a delay associated with the RID, wherein the configuration indicates one or more downlink reference signals transmitted by one or more transmission-reception points (TRPs) to be measured by the UE.

Clause 7. The method of clause 6, wherein the configuration is received based on: the calibration report including a request for the calibration operation, an accuracy of the calibration information associated with the RID being below a threshold, or any combination thereof.

Clause 8. The method of any of clauses 6 to 7, further comprising: obtaining a timing measurement of the one or more downlink reference signals; and transmitting the timing measurement to the network entity to enable the network entity to determine a propagation time between the one or more TRPs and the UE.

Clause 9. The method of any of clauses 6 to 8, further comprising: transmitting, to the RID controller, a request for the RID to be turned OFF during a first measurement occasion of the one or more downlink reference signals and turned ON during a second measurement occasion of the one or more downlink reference signals; obtaining measurements of the one or more downlink reference signals during the first measurement occasion and the second measurement occasion; and determining a delay from the one or more TRPs to the UE via the RID based on the measurements of the one or more downlink reference signals during the first measurement occasion and the second measurement occasion.

Clause 10. The method of clause 9, wherein determining the delay from the one or more TRPs to the UE via the RID comprises: determining a difference between a measurement of the one or more downlink reference signals obtained during the first measurement occasion and a measurement of the one or more downlink reference signals obtained during the second measurement occasion; and determining the delay from the one or more TRPs to the UE via the RID based on the difference.

Clause 11. The method of any of clauses 9 to 10, wherein the request is transmitted to the RID controller based on: a distance between the UE and the RID controller, a comparison of a quality of an indirect path of the one or more downlink reference signals through the RID to a quality of a direct path of the one or more downlink reference signals from the one or more TRPs, a quality of a link between the UE and the RID controller, or any combination thereof.

Clause 12. The method of any of clauses 6 to 11, further comprising: obtaining a propagation time between the one or more TRPs and the RID controller; obtaining a propagation time between the one or more TRPs and the UE; obtaining a propagation time between the UE and the RID controller; and determining a value of the delay associated with the RID based on the propagation time between the one or more TRPs and the RID controller, the propagation time between the one or more TRPs and the UE, and the propagation time between the UE and the RID controller.

Clause 13. The method of clause 12, further comprising: transmitting the value of the delay associated with the RID to the network entity, the RID controller, or both.

Clause 14. The method of any of clauses 6 to 13, further comprising: transmitting a propagation time between the one or more TRPs and the UE; and receiving a value of the delay associated with the RID.

Clause 15. The method of clause 14, wherein the propagation time is transmitted to and the value of the delay associated with the RID is received from: the network entity, or the RID controller.

Clause 16. The method of any of clauses 1 to 15, further comprising: receiving, from the network entity, a request to notify the RID controller to establish a connection with the network entity; and transmitting a notification to the RID controller to establish the connection with the network entity.

Clause 17. The method of any of clauses 1 to 16, further comprising: determining a propagation time between the UE and the RID controller; and transmitting the propagation time to the network entity, the RID controller, or both.

Clause 18. The method of clause 17, wherein determining the propagation time between the UE and the RID controller comprises: obtaining a timing advance associated with a synchronization source common to the UE and the RID controller; transmitting a first sidelink reference signal to the RID controller and requesting a time difference measurement based on the first sidelink reference signal from the RID controller; or requesting the RID controller to transmit a second sidelink reference signal and measuring a second time difference measurement based on the second sidelink reference signal.

Clause 19. The method of any of clauses 1 to 18, further comprising: transmitting, to the RID controller, a request to provide a timing offset of the RID controller with respect to the UE or a synchronization source common to the UE and the RID controller.

Clause 20. The method of any of clauses 1 to 19, further comprising: transmitting, to the RID controller, a request for parameters of the RID; and receiving, from the RID controller, the parameters of the RID.

Clause 21. The method of clause 20, wherein the parameters of the RID comprise: a height of the RID compared to a height of a transceiver of the RID, a location of the RID with respect to an antenna of the RID, an orientation of the RID with respect to the antenna of the RID, or any combination thereof.

Clause 22. The method of any of clauses 1 to 21, wherein the network entity comprises: one or more TRPs, or a location server.

Clause 23. A method of communication performed by a network entity, comprising: receiving, from a user equipment (UE), a calibration report indicating calibration information associated with a reconfigurable intelligence device (RID); and transmitting, to the UE, a first configuration to perform a calibration operation to determine a delay associated with the RID, wherein the first configuration indicates one or more downlink reference signals transmitted by one or more transmission-reception points (TRPs) to be measured by the UE.

Clause 24. The method of clause 23, further comprising: transmitting, to a RID controller associated with the RID, a second configuration to perform the calibration operation to determine the delay associated with the RID, wherein the second configuration indicates the one or more downlink reference signals transmitted by the one or more TRPs to be measured by the RID controller.

Clause 25. The method of clause 24, further comprising: transmitting, to the RID controller, a page to cause the RID controller to switch to a connected state; or transmitting, to the UE, a request to notify the RID controller to establish a connection with the network entity.

Clause 26. The method of any of clauses 23 to 25, further comprising: obtaining a propagation time between the one or more TRPs and a RID controller associated with the RID; obtaining a propagation time between the one or more TRPs and the UE; obtaining a propagation time between the UE and the RID controller; determining a value of the delay associated with the RID based on the propagation time between the one or more TRPs and the RID controller, the propagation time between the one or more TRPs and the UE, and the propagation time between the UE and the RID controller; and transmitting the value of the delay associated with the RID to the UE, the RID controller, or both.

Clause 27. The method of clause 26, wherein obtaining the propagation time between the UE and the RID controller comprises: receiving the propagation time between the UE and the RID controller from the UE or the RID controller.

Clause 28. A user equipment (UE), comprising: at least one memory; at least one transceiver; and at least one processor communicatively coupled to the at least one memory and the at least one transceiver, the at least one processor configured to: transmit, via the at least one transceiver, to a reconfigurable intelligence device (RID) controller, a calibration request for calibration information associated with a RID associated with the RID controller; receive, via the at least one transceiver, from the RID controller, in response to the calibration request, a calibration response; and transmit, via the at least one transceiver, to a network entity, based on the calibration response from the RID controller, a calibration report indicating the calibration information associated with the RID.

Clause 29. The UE of clause 28, wherein the calibration response from the RID controller includes: a constant value of a delay associated with the RID, a maximum value of the delay associated with the RID, a minimum value of the delay associated with the RID, an expected value of the delay associated with the RID, an average value of the delay associated with the RID, a mean value of the delay associated with the RID, a variance of the delay associated with the RID, a precision of the delay associated with the RID, an error associated with the delay associated with the RID, or any combination thereof.

Clause 30. The UE of clause 28, wherein the calibration response received from the RID controller indicates that a delay associated with the RID is not available.

Clause 31. The UE of any of clauses 28 to 30, wherein the calibration report includes: a value of a delay associated with the RID received in the calibration response, or an indication that the delay associated with the RID is not available.

Clause 32. The UE of any of clauses 28 to 31, wherein the calibration report includes a unique identifier of the RID controller.

Clause 33. The UE of any of clauses 28 to 32, wherein the at least one processor is further configured to: receive, via the at least one transceiver, from the network entity, a configuration to perform a calibration operation to determine a delay associated with the RID, wherein the configuration indicates one or more downlink reference signals transmitted by one or more transmission-reception points (TRPs) to be measured by the UE.

Clause 34. The UE of clause 33, wherein the configuration is received based on: the calibration report including a request for the calibration operation, an accuracy of the calibration information associated with the RID being below a threshold, or any combination thereof.

Clause 35. The UE of any of clauses 33 to 34, wherein the at least one processor is further configured to: obtain a timing measurement of the one or more downlink reference signals; and transmit, via the at least one transceiver, the timing measurement to the network entity to enable the network entity to determine a propagation time between the one or more TRPs and the UE.

Clause 36. The UE of any of clauses 33 to 35, wherein the at least one processor is further configured to: transmit, via the at least one transceiver, to the RID controller, a request for the RID to be turned OFF during a first measurement occasion of the one or more downlink reference signals and turned ON during a second measurement occasion of the one or more downlink reference signals; obtain measurements of the one or more downlink reference signals during the first measurement occasion and the second measurement occasion; and determine a delay from the one or more TRPs to the UE via the RID based on the measurements of the one or more downlink reference signals during the first measurement occasion and the second measurement occasion.

Clause 37. The UE of clause 36, wherein the at least one processor configured to determine the delay from the one or more TRPs to the UE via the RID comprises the at least one processor configured to: determine a difference between a measurement of the one or more downlink reference signals obtained during the first measurement occasion and a measurement of the one or more downlink reference signals obtained during the second measurement occasion; and determine the delay from the one or more TRPs to the UE via the RID based on the difference.

Clause 38. The UE of any of clauses 36 to 37, wherein the request is transmitted to the RID controller based on: a distance between the UE and the RID controller, a comparison of a quality of an indirect path of the one or more downlink reference signals through the RID to a quality of a direct path of the one or more downlink reference signals from the one or more TRPs, a quality of a link between the UE and the RID controller, or any combination thereof.

Clause 39. The UE of any of clauses 33 to 38, wherein the at least one processor is further configured to: obtain a propagation time between the one or more TRPs and the RID controller; obtain a propagation time between the one or more TRPs and the UE; obtain a propagation time between the UE and the RID controller; and determine a value of the delay associated with the RID based on the propagation time between the one or more TRPs and the RID controller, the propagation time between the one or more TRPs and the UE, and the propagation time between the UE and the RID controller.

Clause 40. The UE of clause 39, wherein the at least one processor is further configured to: transmit, via the at least one transceiver, the value of the delay associated with the RID to the network entity, the RID controller, or both.

Clause 41. The UE of any of clauses 33 to 40, wherein the at least one processor is further configured to: transmit, via the at least one transceiver, a propagation time between the one or more TRPs and the UE; and receive, via the at least one transceiver, a value of the delay associated with the RID.

Clause 42. The UE of clause 41, wherein the propagation time is transmitted to and the value of the delay associated with the RID is received from: the network entity, or the RID controller.

Clause 43. The UE of any of clauses 28 to 42, wherein the at least one processor is further configured to: receive, via the at least one transceiver, from the network entity, a request to notify the RID controller to establish a connection with the network entity; and transmit, via the at least one transceiver, a notification to the RID controller to establish the connection with the network entity.

Clause 44. The UE of any of clauses 28 to 43, wherein the at least one processor is further configured to: determine a propagation time between the UE and the RID controller; and transmit, via the at least one transceiver, the propagation time to the network entity, the RID controller, or both.

Clause 45. The UE of clause 44, wherein the at least one processor configured to determine the propagation time between the UE and the RID controller comprises the at least one processor configured to: obtain a timing advance associated with a synchronization source common to the UE and the RID controller; transmit, via the at least one transceiver, a first sidelink reference signal to the RID controller and requesting a time difference measurement based on the first sidelink reference signal from the RID controller; or request the RID controller to transmit a second sidelink reference signal and measuring a second time difference measurement based on the second sidelink reference signal.

Clause 46. The UE of any of clauses 28 to 45, wherein the at least one processor is further configured to: transmit, via the at least one transceiver, to the RID controller, a request to provide a timing offset of the RID controller with respect to the UE or a synchronization source common to the UE and the RID controller.

Clause 47. The UE of any of clauses 28 to 46, wherein the at least one processor is further configured to: transmit, via the at least one transceiver, to the RID controller, a request for parameters of the RID; and receive, via the at least one transceiver, from the RID controller, the parameters of the RID.

Clause 48. The UE of clause 47, wherein the parameters of the RID comprise: a height of the RID compared to a height of a transceiver of the RID, a location of the RID with respect to an antenna of the RID, an orientation of the RID with respect to the antenna of the RID, or any combination thereof.

Clause 49. The UE of any of clauses 28 to 48, wherein the network entity comprises: one or more TRPs, or a location server.

Clause 50. A network entity, comprising: at least one memory; at least one transceiver; and at least one processor communicatively coupled to the at least one memory and the at least one transceiver, the at least one processor configured to: receive, via the at least one transceiver, from a user equipment (UE), a calibration report indicating calibration information associated with a reconfigurable intelligence device (RID); and transmit, via the at least one transceiver, to the UE, a first configuration to perform a calibration operation to determine a delay associated with the RID, wherein the first configuration indicates one or more downlink reference signals transmitted by one or more transmission-reception points (TRPs) to be measured by the UE.

Clause 51. The network entity of clause 50, wherein the at least one processor is further configured to: transmit, via the at least one transceiver, to a RID controller associated with the RID, a second configuration to perform the calibration operation to determine the delay associated with the RID, wherein the second configuration indicates the one or more downlink reference signals transmitted by the one or more TRPs to be measured by the RID controller.

Clause 52. The network entity of clause 51, wherein the at least one processor is further configured to: transmit, via the at least one transceiver, to the RID controller, a page to cause the RID controller to switch to a connected state; or transmit, via the at least one transceiver, to the UE, a request to notify the RID controller to establish a connection with the network entity.

Clause 53. The network entity of any of clauses 50 to 52, wherein the at least one processor is further configured to: obtain a propagation time between the one or more TRPs and a RID controller associated with the RID; obtain a propagation time between the one or more TRPs and the UE; obtain a propagation time between the UE and the RID controller; determine a value of the delay associated with the RID based on the propagation time between the one or more TRPs and the RID controller, the propagation time between the one or more TRPs and the UE, and the propagation time between the UE and the RID controller; and transmit, via the at least one transceiver, the value of the delay associated with the RID to the UE, the RID controller, or both.

Clause 54. The network entity of clause 53, wherein the at least one processor configured to obtain the propagation time between the UE and the RID controller comprises the at least one processor configured to: receive, via the at least one transceiver, the propagation time between the UE and the RID controller from the UE or the RID controller.

Clause 55. A user equipment (UE), comprising: means for transmitting, to a reconfigurable intelligence device (RID) controller, a calibration request for calibration information associated with a RID associated with the RID controller; means for receiving, from the RID controller, in response to the calibration request, a calibration response; and means for transmitting, to a network entity, based on the calibration response from the RID controller, a calibration report indicating the calibration information associated with the RID.

Clause 56. The UE of clause 55, wherein the calibration response from the RID controller includes: a constant value of a delay associated with the RID, a maximum value of the delay associated with the RID, a minimum value of the delay associated with the RID, an expected value of the delay associated with the RID, an average value of the delay associated with the RID, a mean value of the delay associated with the RID, a variance of the delay associated with the RID, a precision of the delay associated with the RID, an error associated with the delay associated with the RID, or any combination thereof.

Clause 57. The UE of clause 55, wherein the calibration response received from the RID controller indicates that a delay associated with the RID is not available.

Clause 58. The UE of any of clauses 55 to 57, wherein the calibration report includes: a value of a delay associated with the RID received in the calibration response, or an indication that the delay associated with the RID is not available.

Clause 59. The UE of any of clauses 55 to 58, wherein the calibration report includes a unique identifier of the RID controller.

Clause 60. The UE of any of clauses 55 to 59, further comprising: means for receiving, from the network entity, a configuration to perform a calibration operation to determine a delay associated with the RID, wherein the configuration indicates one or more downlink reference signals transmitted by one or more transmission-reception points (TRPs) to be measured by the UE.

Clause 61. The UE of clause 60, wherein the configuration is received based on: the calibration report including a request for the calibration operation, an accuracy of the calibration information associated with the RID being below a threshold, or any combination thereof.

Clause 62. The UE of any of clauses 60 to 61, further comprising: means for obtaining a timing measurement of the one or more downlink reference signals; and means for transmitting the timing measurement to the network entity to enable the network entity to determine a propagation time between the one or more TRPs and the UE.

Clause 63. The UE of any of clauses 60 to 62, further comprising: means for transmitting, to the RID controller, a request for the RID to be turned OFF during a first measurement occasion of the one or more downlink reference signals and turned ON during a second measurement occasion of the one or more downlink reference signals; means for obtaining measurements of the one or more downlink reference signals during the first measurement occasion and the second measurement occasion; and means for determining a delay from the one or more TRPs to the UE via the RID based on the measurements of the one or more downlink reference signals during the first measurement occasion and the second measurement occasion.

Clause 64. The UE of clause 63, wherein the means for determining the delay from the one or more TRPs to the UE via the RID comprises: means for determining a difference between a measurement of the one or more downlink reference signals obtained during the first measurement occasion and a measurement of the one or more downlink reference signals obtained during the second measurement occasion; and means for determining the delay from the one or more TRPs to the UE via the RID based on the difference.

Clause 65. The UE of any of clauses 63 to 64, wherein the request is transmitted to the RID controller based on: a distance between the UE and the RID controller, a comparison of a quality of an indirect path of the one or more downlink reference signals through the RID to a quality of a direct path of the one or more downlink reference signals from the one or more TRPs, a quality of a link between the UE and the RID controller, or any combination thereof.

Clause 66. The UE of any of clauses 60 to 65, further comprising: means for obtaining a propagation time between the one or more TRPs and the RID controller; means for obtaining a propagation time between the one or more TRPs and the UE; means for obtaining a propagation time between the UE and the RID controller; and means for determining a value of the delay associated with the RID based on the propagation time between the one or more TRPs and the RID controller, the propagation time between the one or more TRPs and the UE, and the propagation time between the UE and the RID controller.

Clause 67. The UE of clause 66, further comprising: means for transmitting the value of the delay associated with the RID to the network entity, the RID controller, or both.

Clause 68. The UE of any of clauses 60 to 67, further comprising: means for transmitting a propagation time between the one or more TRPs and the UE; and means for receiving a value of the delay associated with the RID.

Clause 69. The UE of clause 68, wherein the propagation time is transmitted to and the value of the delay associated with the RID is received from: the network entity, or the RID controller.

Clause 70. The UE of any of clauses 55 to 69, further comprising: means for receiving, from the network entity, a request to notify the RID controller to establish a connection with the network entity; and means for transmitting a notification to the RID controller to establish the connection with the network entity.

Clause 71. The UE of any of clauses 55 to 70, further comprising: means for determining a propagation time between the UE and the RID controller; and means for transmitting the propagation time to the network entity, the RID controller, or both.

Clause 72. The UE of clause 71, wherein the means for determining the propagation time between the UE and the RID controller comprises: means for obtaining a timing advance associated with a synchronization source common to the UE and the RID controller; means for transmitting a first sidelink reference signal to the RID controller and requesting a time difference measurement based on the first sidelink reference signal from the RID controller; or means for requesting the RID controller to transmit a second sidelink reference signal and measuring a second time difference measurement based on the second sidelink reference signal.

Clause 73. The UE of any of clauses 55 to 72, further comprising: means for transmitting, to the RID controller, a request to provide a timing offset of the RID controller with respect to the UE or a synchronization source common to the UE and the RID controller.

Clause 74. The UE of any of clauses 55 to 73, further comprising: means for transmitting, to the RID controller, a request for parameters of the RID; and means for receiving, from the RID controller, the parameters of the RID.

Clause 75. The UE of clause 74, wherein the parameters of the RID comprise: a height of the RID compared to a height of a transceiver of the RID, a location of the RID with respect to an antenna of the RID, an orientation of the RID with respect to the antenna of the RID, or any combination thereof.

Clause 76. The UE of any of clauses 55 to 75, wherein the network entity comprises: one or more TRPs, or a location server.

Clause 77. A network entity, comprising: means for receiving, from a user equipment (UE), a calibration report indicating calibration information associated with a reconfigurable intelligence device (RID); and means for transmitting, to the UE, a first configuration to perform a calibration operation to determine a delay associated with the RID, wherein the first configuration indicates one or more downlink reference signals transmitted by one or more transmission-reception points (TRPs) to be measured by the UE.

Clause 78. The network entity of clause 77, further comprising: means for transmitting, to a RID controller associated with the RID, a second configuration to perform the calibration operation to determine the delay associated with the RID, wherein the second configuration indicates the one or more downlink reference signals transmitted by the one or more TRPs to be measured by the RID controller.

Clause 79. The network entity of clause 78, further comprising: means for transmitting, to the RID controller, a page to cause the RID controller to switch to a connected state; or means for transmitting, to the UE, a request to notify the RID controller to establish a connection with the network entity.

Clause 80. The network entity of any of clauses 77 to 79, further comprising: means for obtaining a propagation time between the one or more TRPs and a RID controller associated with the RID; means for obtaining a propagation time between the one or more TRPs and the UE; means for obtaining a propagation time between the UE and the RID controller; means for determining a value of the delay associated with the RID based on the propagation time between the one or more TRPs and the RID controller, the propagation time between the one or more TRPs and the UE, and the propagation time between the UE and the RID controller; and means for transmitting the value of the delay associated with the RID to the UE, the RID controller, or both.

Clause 81. The network entity of clause 80, wherein the means for obtaining the propagation time between the UE and the RID controller comprises: means for receiving the propagation time between the UE and the RID controller from the UE or the RID controller.

Clause 82. A non-transitory computer-readable medium storing computer-executable instructions that, when executed by a user equipment (UE), cause the UE to: transmit, to a reconfigurable intelligence device (RID) controller, a calibration request for calibration information associated with a RID associated with the RID controller; receive, from the RID controller, in response to the calibration request, a calibration response; and transmit, to a network entity, based on the calibration response from the RID controller, a calibration report indicating the calibration information associated with the RID.

Clause 83. The non-transitory computer-readable medium of clause 82, wherein the calibration response from the RID controller includes: a constant value of a delay associated with the RID, a maximum value of the delay associated with the RID, a minimum value of the delay associated with the RID, an expected value of the delay associated with the RID, an average value of the delay associated with the RID, a mean value of the delay associated with the RID, a variance of the delay associated with the RID, a precision of the delay associated with the RID, an error associated with the delay associated with the RID, or any combination thereof.

Clause 84. The non-transitory computer-readable medium of clause 82, wherein the calibration response received from the RID controller indicates that a delay associated with the RID is not available.

Clause 85. The non-transitory computer-readable medium of any of clauses 82 to 84, wherein the calibration report includes: a value of a delay associated with the RID received in the calibration response, or an indication that the delay associated with the RID is not available.

Clause 86. The non-transitory computer-readable medium of any of clauses 82 to 85, wherein the calibration report includes a unique identifier of the RID controller.

Clause 87. The non-transitory computer-readable medium of any of clauses 82 to 86, further comprising computer-executable instructions that, when executed by the UE, cause the UE to: receive, from the network entity, a configuration to perform a calibration operation to determine a delay associated with the RID, wherein the configuration indicates one or more downlink reference signals transmitted by one or more transmission-reception points (TRPs) to be measured by the UE.

Clause 88. The non-transitory computer-readable medium of clause 87, wherein the configuration is received based on: the calibration report including a request for the calibration operation, an accuracy of the calibration information associated with the RID being below a threshold, or any combination thereof.

Clause 89. The non-transitory computer-readable medium of any of clauses 87 to 88, further comprising computer-executable instructions that, when executed by the UE, cause the UE to: obtain a timing measurement of the one or more downlink reference signals; and transmit the timing measurement to the network entity to enable the network entity to determine a propagation time between the one or more TRPs and the UE.

Clause 90. The non-transitory computer-readable medium of any of clauses 87 to 89, further comprising computer-executable instructions that, when executed by the UE, cause the UE to: transmit, to the RID controller, a request for the RID to be turned OFF during a first measurement occasion of the one or more downlink reference signals and turned ON during a second measurement occasion of the one or more downlink reference signals; obtain measurements of the one or more downlink reference signals during the first measurement occasion and the second measurement occasion; and determine a delay from the one or more TRPs to the UE via the RID based on the measurements of the one or more downlink reference signals during the first measurement occasion and the second measurement occasion.

Clause 91. The non-transitory computer-readable medium of clause 90, wherein the computer-executable instructions that, when executed by the UE, cause the UE to determine the delay from the one or more TRPs to the UE via the RID comprise computer-executable instructions that, when executed by the UE, cause the UE to: determine a difference between a measurement of the one or more downlink reference signals obtained during the first measurement occasion and a measurement of the one or more downlink reference signals obtained during the second measurement occasion; and determine the delay from the one or more TRPs to the UE via the RID based on the difference.

Clause 92. The non-transitory computer-readable medium of any of clauses 90 to 91, wherein the request is transmitted to the RID controller based on: a distance between the UE and the RID controller, a comparison of a quality of an indirect path of the one or more downlink reference signals through the RID to a quality of a direct path of the one or more downlink reference signals from the one or more TRPs, a quality of a link between the UE and the RID controller, or any combination thereof.

Clause 93. The non-transitory computer-readable medium of any of clauses 87 to 92, further comprising computer-executable instructions that, when executed by the UE, cause the UE to: obtain a propagation time between the one or more TRPs and the RID controller; obtain a propagation time between the one or more TRPs and the UE; obtain a propagation time between the UE and the RID controller; and determine a value of the delay associated with the RID based on the propagation time between the one or more TRPs and the RID controller, the propagation time between the one or more TRPs and the UE, and the propagation time between the UE and the RID controller.

Clause 94. The non-transitory computer-readable medium of clause 93, further comprising computer-executable instructions that, when executed by the UE, cause the UE to: transmit the value of the delay associated with the RID to the network entity, the RID controller, or both.

Clause 95. The non-transitory computer-readable medium of any of clauses 87 to 94, further comprising computer-executable instructions that, when executed by the UE, cause the UE to: transmit a propagation time between the one or more TRPs and the UE; and receive a value of the delay associated with the RID.

Clause 96. The non-transitory computer-readable medium of clause 95, wherein the propagation time is transmitted to and the value of the delay associated with the RID is received from: the network entity, or the RID controller.

Clause 97. The non-transitory computer-readable medium of any of clauses 82 to 96, further comprising computer-executable instructions that, when executed by the UE, cause the UE to: receive, from the network entity, a request to notify the RID controller to establish a connection with the network entity; and transmit a notification to the RID controller to establish the connection with the network entity.

Clause 98. The non-transitory computer-readable medium of any of clauses 82 to 97, further comprising computer-executable instructions that, when executed by the UE, cause the UE to: determine a propagation time between the UE and the RID controller; and transmit the propagation time to the network entity, the RID controller, or both.

Clause 99. The non-transitory computer-readable medium of clause 98, wherein the computer-executable instructions that, when executed by the UE, cause the UE to determine the propagation time between the UE and the RID controller comprise computer-executable instructions that, when executed by the UE, cause the UE to: obtain a timing advance associated with a synchronization source common to the UE and the RID controller; transmit a first sidelink reference signal to the RID controller and requesting a time difference measurement based on the first sidelink reference signal from the RID controller; or request the RID controller to transmit a second sidelink reference signal and measuring a second time difference measurement based on the second sidelink reference signal.

Clause 100. The non-transitory computer-readable medium of any of clauses 82 to 99, further comprising computer-executable instructions that, when executed by the UE, cause the UE to: transmit, to the RID controller, a request to provide a timing offset of the RID controller with respect to the UE or a synchronization source common to the UE and the RID controller.

Clause 101. The non-transitory computer-readable medium of any of clauses 82 to 100, further comprising computer-executable instructions that, when executed by the UE, cause the UE to: transmit, to the RID controller, a request for parameters of the RID; and receive, from the RID controller, the parameters of the RID.

Clause 102. The non-transitory computer-readable medium of clause 101, wherein the parameters of the RID comprise: a height of the RID compared to a height of a transceiver of the RID, a location of the RID with respect to an antenna of the RID, an orientation of the RID with respect to the antenna of the RID, or any combination thereof.

Clause 103. The non-transitory computer-readable medium of any of clauses 82 to 102, wherein the network entity comprises: one or more TRPs, or a location server.

Clause 104. A non-transitory computer-readable medium storing computer-executable instructions that, when executed by a network entity, cause the network entity to: receive, from a user equipment (UE), a calibration report indicating calibration information associated with a reconfigurable intelligence device (RID); and transmit, to the UE, a first configuration to perform a calibration operation to determine a delay associated with the RID, wherein the first configuration indicates one or more downlink reference signals transmitted by one or more transmission-reception points (TRPs) to be measured by the UE.

Clause 105. The non-transitory computer-readable medium of clause 104, further comprising computer-executable instructions that, when executed by the network entity, cause the network entity to: transmit, to a RID controller associated with the RID, a second configuration to perform the calibration operation to determine the delay associated with the RID, wherein the second configuration indicates the one or more downlink reference signals transmitted by the one or more TRPs to be measured by the RID controller.

Clause 106. The non-transitory computer-readable medium of clause 105, further comprising computer-executable instructions that, when executed by the network entity, cause the network entity to: transmit, to the RID controller, a page to cause the RID controller to switch to a connected state; or transmit, to the UE, a request to notify the RID controller to establish a connection with the network entity.

Clause 107. The non-transitory computer-readable medium of any of clauses 104 to 106, further comprising computer-executable instructions that, when executed by the network entity, cause the network entity to: obtain a propagation time between the one or more TRPs and a RID controller associated with the RID; obtain a propagation time between the one or more TRPs and the UE; obtain a propagation time between the UE and the RID controller; determine a value of the delay associated with the RID based on the propagation time between the one or more TRPs and the RID controller, the propagation time between the one or more TRPs and the UE, and the propagation time between the UE and the RID controller; and transmit the value of the delay associated with the RID to the UE, the RID controller, or both.

Clause 108. The non-transitory computer-readable medium of clause 107, wherein the computer-executable instructions that, when executed by the network entity, cause the network entity to obtain the propagation time between the UE and the RID controller comprise computer-executable instructions that, when executed by the network entity, cause the network entity to: receive the propagation time between the UE and the RID controller from the UE or the RID controller.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

A complete listing of the claims, including current amendments (if any), is as follows:

1. A method of wireless communication performed by a user equipment (UE), comprising:
transmitting, to a reconfigurable intelligence device (RID) controller, a calibration request for calibration information associated with a RID associated with the RID controller;
receiving, from the RID controller, in response to the calibration request, a calibration response; and
transmitting, to a network entity, based on the calibration response from the RID controller, a calibration report indicating the calibration information associated with the RID.

2. The method of claim 1, wherein the calibration response from the RID controller includes:
a constant value of a delay associated with the RID,
a maximum value of the delay associated with the RID,
a minimum value of the delay associated with the RID,
an expected value of the delay associated with the RID,
an average value of the delay associated with the RID,
a mean value of the delay associated with the RID,
a variance of the delay associated with the RID,
a precision of the delay associated with the RID,
an error associated with the delay associated with the RID, or
any combination thereof.

3. The method of claim 1, wherein the calibration response received from the RID controller indicates that a delay associated with the RID is not available.

4. The method of claim 1, wherein the calibration report includes:
a value of a delay associated with the RID received in the calibration response, or
an indication that the delay associated with the RID is not available.

5. The method of claim 1, wherein the calibration report includes a unique identifier of the RID controller.

6. The method of claim 1, further comprising:
receiving, from the network entity, a configuration to perform a calibration operation to determine a delay associated with the RID, wherein the configuration indicates one or more downlink reference signals transmitted by one or more transmission-reception points (TRPs) to be measured by the UE.

7. The method of claim 6, wherein the configuration is received based on:
the calibration report including a request for the calibration operation,
an accuracy of the calibration information associated with the RID being below a threshold, or
any combination thereof.

8. The method of claim 6, further comprising:
obtaining a timing measurement of the one or more downlink reference signals; and
transmitting the timing measurement to the network entity to enable the network entity to determine a propagation time between the one or more TRPs and the UE.

9. The method of claim 6, further comprising:
transmitting, to the RID controller, a request for the RID to be turned OFF during a first measurement occasion of the one or more downlink reference signals and turned ON during a second measurement occasion of the one or more downlink reference signals;
obtaining measurements of the one or more downlink reference signals during the first measurement occasion and the second measurement occasion; and
determining a delay from the one or more TRPs to the UE via the RID based on the measurements of the one or more downlink reference signals during the first measurement occasion and the second measurement occasion.

10. The method of claim 9, wherein determining the delay from the one or more TRPs to the UE via the RID comprises:
determining a difference between a measurement of the one or more downlink reference signals obtained during the first measurement occasion and a measurement of the one or more downlink reference signals obtained during the second measurement occasion; and
determining the delay from the one or more TRPs to the UE via the RID based on the difference.

11. The method of claim 9, wherein the request is transmitted to the RID controller based on:
a distance between the UE and the RID controller,
a comparison of a quality of an indirect path of the one or more downlink reference signals through the RID to a quality of a direct path of the one or more downlink reference signals from the one or more TRPs,
a quality of a link between the UE and the RID controller, or
any combination thereof.

12. The method of claim 6, further comprising:
obtaining a propagation time between the one or more TRPs and the RID controller;
obtaining a propagation time between the one or more TRPs and the UE;
obtaining a propagation time between the UE and the RID controller; and
determining a value of the delay associated with the RID based on the propagation time between the one or more TRPs and the RID controller, the propagation time between the one or more TRPs and the UE, and the propagation time between the UE and the RID controller.

13. The method of claim 12, further comprising:
transmitting the value of the delay associated with the RID to the network entity, the RID controller, or both.

14. The method of claim 6, further comprising:
transmitting a propagation time between the one or more TRPs and the UE; and
receiving a value of the delay associated with the RID.

15. The method of claim 14, wherein the propagation time is transmitted to and the value of the delay associated with the RID is received from:
the network entity, or
the RID controller.

16. The method of claim 1, further comprising:
receiving, from the network entity, a request to notify the RID controller to establish a connection with the network entity; and
transmitting a notification to the RID controller to establish the connection with the network entity.

17. The method of claim 1, further comprising:
determining a propagation time between the UE and the RID controller; and
transmitting the propagation time to the network entity, the RID controller, or both.

18. The method of claim 17, wherein determining the propagation time between the UE and the RID controller comprises:
obtaining a timing advance associated with a synchronization source common to the UE and the RID controller;
transmitting a first sidelink reference signal to the RID controller and requesting a time difference measurement based on the first sidelink reference signal from the RID controller; or
requesting the RID controller to transmit a second sidelink reference signal and measuring a second time difference measurement based on the second sidelink reference signal.

19. The method of claim 1, further comprising:
transmitting, to the RID controller, a request to provide a timing offset of the RID controller with respect to the UE or a synchronization source common to the UE and the RID controller.

20. The method of claim 1, further comprising:
transmitting, to the RID controller, a request for parameters of the RID; and
receiving, from the RID controller, the parameters of the RID.

21. (canceled)

22. (canceled)

23. (canceled)

24. (canceled)

25. (canceled)

26. (canceled)

27. (canceled)

28. (canceled)

29. (canceled)

30. (canceled)
